(19) United States
(12) Patent Application Publication
(10) Pub. No.: US 2019/0237896 A1
(43) Pub. Date: Aug. 1, 2019

(54) IMPLEMENTING FERROFLUID POWER PLUG CURRENT INDICATOR

(71) Applicant: International Business Machines Corporation, Armonk, NY (US)

(72) Inventors: Stuart B. Benefield, Durham, NC (US); Joseph Kuczynski, North Port, FL (US); Samuel Conner, Apex, NC (US); Jonathan Jackson, Cedar Grove, NC (US)

(21) Appl. No.: 15/884,694

(22) Filed: Jan. 31, 2018

(51) Int. Cl. H01R 13/46; H01F 1/44

(52) U.S. Cl. CPC H01R 13/465; H01F 1/445

(57) ABSTRACT

A method and structures are provided for implementing a current indicator for electrical connectors, such as power plug connectors. A ferrofluid is embedded into a power plug connector. The ferrofluid is influenced by a magnetic field created by flowing current to expose a current indicator. The current indicator is not exposed when current is not flowing

### FIELD OF THE INVENTION

The present invention relates generally to the data processing field, and more particularly, relates to a method and structures for implementing a current indicator for electrical connectors, such as power plug connectors.

### DESCRIPTION OF THE RELATED ART

When working with high voltage AC/DC cables, it is imperative to know whether current is flowing in the cable before unplugging it. To unplug a cable safely, the power source must be turned off. When working with multiple power sources and circuit breakers, mistakes happen and the wrong one can be turned off causing a safety concern.

A need exists for an effective way to indicate if current is flowing for low and high voltage, AC and DC electrical connectors without requiring any circuit provided with the cable or requiring additional equipment. It is desirable to provide an indicator built directly into the plug so a user knows when current is flowing to prevent possible electric shock or injury.

### SUMMARY OF THE INVENTION

Principal aspects of the present invention are to provide a method and structures for implementing a current indicator for electrical connectors, such as power plug connectors. Other important aspects of the present invention are to provide such method and structures substantially without negative effects and that overcome many of the disadvantages of prior art arrangements.

In brief, a method and structures are provided for implementing a current indicator for electrical connectors, such as power plug connectors. A ferrofluid is embedded into a power plug connector of cables. The ferrofluid is influenced by a magnetic field created by flowing current to expose a current indicator. The current indicator is not exposed when current is not flowing.

In accordance with features of the invention, the power plug connector can be used with both AC and DC and can be used with various voltages including high voltage, without requiring internal circuitry.

In accordance with features of the invention, the ferrofluid includes a selected material that possesses spontaneous magnetic polarization such that the polarization can be reversed by a magnetic field.

In accordance with features of the invention, the ferrofluid is contained in a dedicated volume of a plug shell of a power plug connector body with a transparent, impact resistant plastic window that enables visual observation of the underlying current indicator.

In accordance with features of the invention, the body of the power plug connector is formed of a selected electrically insulative material having predefined rigidity and strength, such as a selected plastic material.

In accordance with features of the invention, the ferrofluid is received within a defined slot formed in the connector body.

In accordance with features of the invention, the ferrofluid includes ferromagnetic or ferromagnetic particles which are strongly magnetized (aligned) by an externally applied magnetic field in which the material is placed.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a perspective view not to scale illustrating an example power plug connector for implementing a current indicator for electrical connectors schematically illustrating the indicator visible when power to the cable is present in accordance with the preferred embodiment;

FIG. 2 is a perspective view not to scale illustrating the power plug connector when power to the cable is not present and the indicator is not visible in accordance with the preferred embodiment; and.

FIGS. 3A and 3B illustrate an example predefined volume of the power plug connector containing the indicator and ferrofluid, the indicator covered by the ferrofluid and not visible when power to the cable is not present and the indicator is visible when power to the cable is present moving ferrofluid in accordance with the preferred embodiment.

### DETAILED DESCRIPTION OF THE PREFERRED EMBODIMENTS

In the following detailed description of embodiments of the invention, reference is made to the accompanying drawings, which illustrate example embodiments by which the invention may be practiced. It is to be understood that other embodiments may be utilized and structural changes may be made without departing from the scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In accordance with features of the invention, a method and structures are provided for implementing a current indicator for electrical connectors including power plug connectors. An indicator is provided that shows if current is flowing for low/high voltage AC or DC without embedding any circuit into the cable or requiring additional equipment. The indicator is built directly into the plug so a technician will always know if current is flowing for preventing electric shock. When a ferrofluid is exposed to a magnetic field, it will align with the field and be pulled towards the source. The present invention uses this property to embed ferrofluid into the plugs of high voltage (HV) AC/DC cables to indicate if current is flowing.

In accordance with features of the invention, a method and structures are provided for implementing a current indicator for electrical connectors, such as power plug connectors. A ferrofluid is provided within a dedicated volume of a power plug connector. The ferrofluid is influenced by a magnetic field created by flowing current to expose a current indicator. The current indicator is not exposed when current is not flowing.

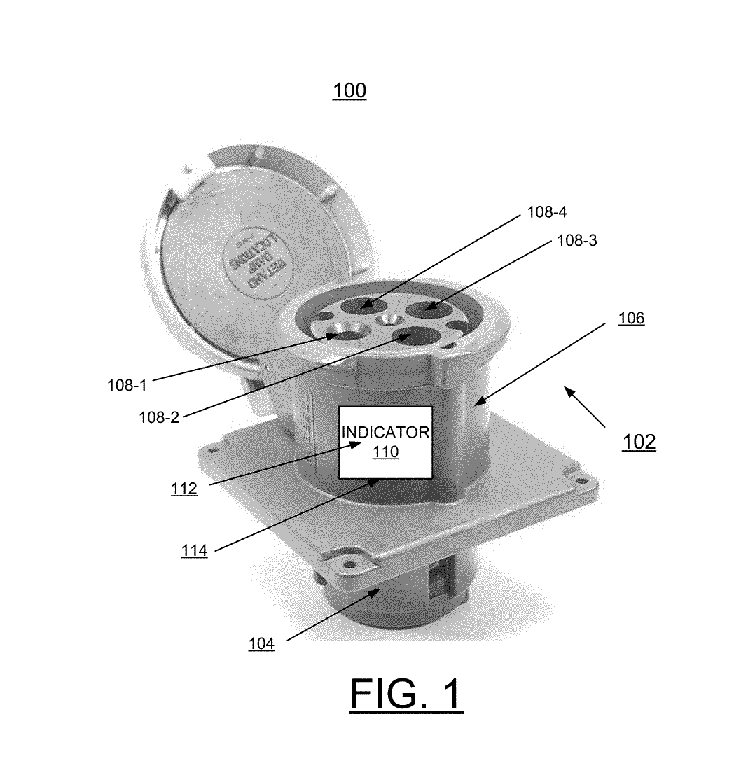

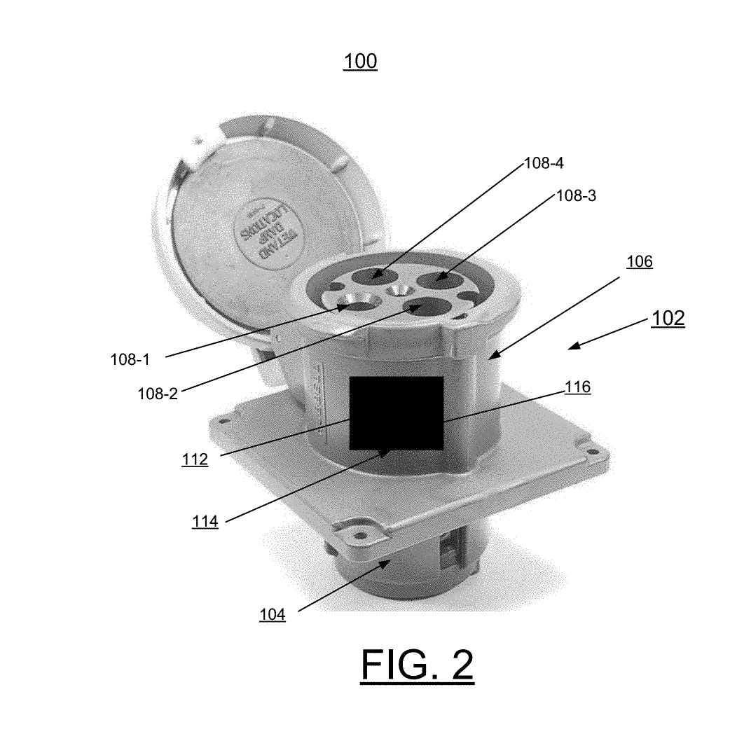

Referring now to FIG. 1, there is schematically shown an example power plug connector generally designated by the reference character 100 for implementing a current indicator for electrical connectors schematically illustrating the indicator visible when power to the cable is present in accordance with the preferred embodiments for example, as further illustrated and described with respect to FIG. 2.

Referring to FIGS. 1 and 2, the power plug connector 100 includes a connector body generally designated by the reference character 102. As shown, the connector body 102 includes a mounting shell 104 and plug shell female mating end 106. The power plug connector 100 includes a plurality of conductors 108-1, 108-2, 108-3 and 108-4. As shown, the conductors 108-1, 108-2, 108-3 and 108-4 have a circular shape; however various shapes can be used.

In accordance with features of the invention, a current indicator 110 is exposed below a transparent, impact resistant plastic window 112 that enables visual observation of the underlying indicator 110 labeled INDICATOR. The current indicator 110 is visible only when current is flowing when power to the electrical connector 100 is present; the current indicator 110 is not visible when current is not flowing. A ferrofluid compartment or dedicated volume generally designated by the reference character 114 in the plug shell female mating end 106 contains the current indicator 110 below the transparent, impact resistant plastic window 112.

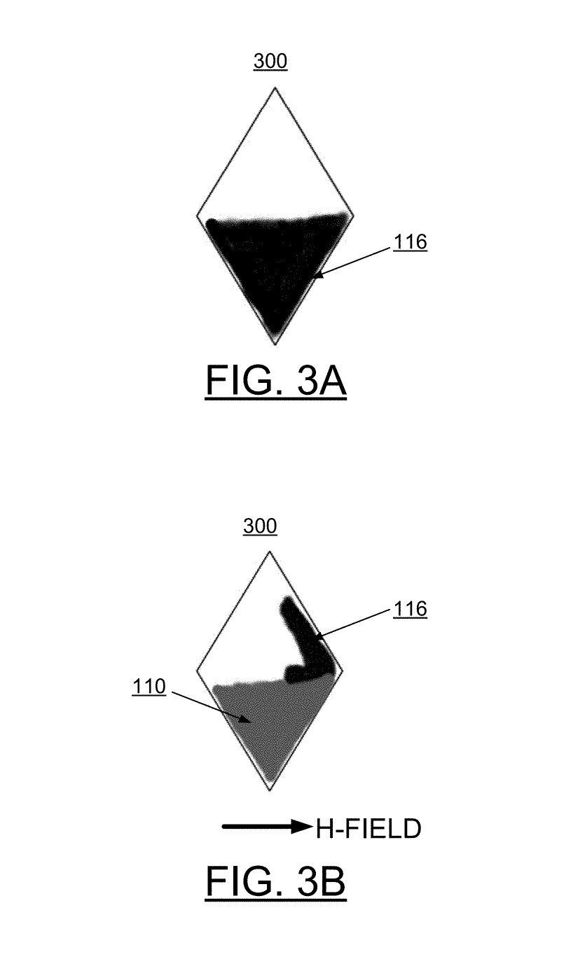

As shown, the window 112 is positioned between selected conductors 108, such as conductors 108-1 and 108-2 and provides visual access to the ferrofluid compartment 114 which is molded into the plastic connector body 106 encasing the conductors. The compartment 114 contains the ferrofluid and includes, for example, a red field or red current present indicator 110 that indicates that current is present. An example dedicated volume 300 is illustrated and described with respect to FIGS. 3A and 3B.

A ferrofluid 116 is contained within the dedicated volume 114 in the plug shell 104 has an inherent property that when it is exposed to a magnetic field, the ferrofluid 116 aligns with the field and is pulled towards the source. As shown in FIG. 1, when current is flowing in the connector, the current creates a magnetic field around the dedicated volume 114 in the plug shell female mating end 106 based on the right hand rule. By taking advantage of this property, the properties of ferrofluid 116 are used to indicate if current is flowing with no internal circuitry required.

In accordance with features of the invention, the ferrofluid 116 advantageously is black, hence opaque and not able to be seen through, covering the red indicator 110 if there is no magnetic field (H-field) present. If current is present, the associated magnetic field will draw the ferrofluid 116 to one side, exposing the red current present indicator which will be visible through the window 112.

When a current is not present, the ferrofluid 116 acts like black water covering the indicator 110 underneath. When current begins flowing, the ferrofluid 116 reacts to the magnetic field and is pulled to the side of volume 114 exposing the current indicator 110 underneath. The transparent window 112 enables visual observation of the underlying current indicator 110.

In FIG. 2, the ferrofluid 116 covers the indicator 110 underneath when a current flow is not present. As shown in FIG. 1, the magnetic field created by flowing current to expose the indicator 110 provides a technician notice that current flow is present.

It should be understood that various ferroelectric substances can be used for the ferrofluid 116. In accordance with features of the invention, the ferrofluid 116 includes ferromagnetic or ferromagnetic particles which are strongly magnetized (aligned) by an externally applied magnetic field in which the material is placed. For example, ferrofluid 116 is about 5% magnetic solids, 10% surfactant, and 85% carrier, by volume. One example, ferrofluid 116 uses magnetite for the magnetic particles, oleic acid as the surfactant, and kerosene as the carrier fluid to suspend the particles.

In accordance with features of the invention, the present invention can be used with various connector types. For example, in other connector types the window 112 and ferrofluid 116 can be positioned on a male end in the connector body provided that it is positioned between two conductors. Assuming that the window 110 is approximately 0.5″×0.25″ and that the connector body plastic thickness is 0.0625″, the volume is 0.0078 cu in or 0.128 cm³ for ferrofluid compartment 114. Using the above example ferrofluid composition, the density of the ferrofluid 116 is roughly 1.035 g/cm³. With the compartment filled to about 50% of its total volume, merely 132 mg of ferrofluid 116 is required.

In accordance with features of the invention, the present invention can be used with a wide temperature range depending on the carrier. For example, the temperature range for kerosene ranges from the freezing point of −40 degrees-C to its auto ignition temperature (the point at which the vapor ignites spontaneously) of 220 degrees-C. The flash point is much lower (37-65 degrees-C), but with the fluid 116 contained in a sealed compartment, this is not a concern.

Referring to FIGS. 3A and 3B, there is shown an example predefined volume generally designated by the reference character 300 of the power plug connector 100 containing the indicator 110 and ferrofluid 116.

In FIG. 3A, the ferroelectric compartment 300 contains the indicator 110 which is covered by the ferrofluid 116 and is not visible when current flow and power is not present, as also shown in FIG. 2

In FIG. 3B, the ferroelectric compartment 300 contains the indicator 110 which is visible when current flows and power is present with the magnetic field (H-field) moving ferrofluid 116 to the side of the volume 300 in accordance with the preferred embodiment.

The connector body 102 is formed of a selected electrically insulative material having predefined rigidity and strength, such as a selected plastic material. The connectors 108 are formed of a selected electrically conductive material, such as a copper alloy, beryllium copper or various other electrically conductive materials can be used, such as TiN, TaN, W, WN, Al, Cu, Ni, Co, Ru or a combination thereof.

While the present invention has been described with reference to the details of the embodiments of the invention shown in the drawing, these details are not intended to limit the scope of the invention as claimed in the appended claims.

1. A structure for implementing a current indicator for electrical power plug connectors comprising;
a power plug connector including a connector body; said connector body encasing a plurality of conductors;
a window in said connector body positioned between selected ones of said plurality of conductors;
a compartment embedded into the power plug connector containing a ferrofluid and containing a current indicator; and
said current indicator disposed below said window, said ferrofluid being influenced by a magnetic field created by flowing current in said conductors to expose said current indicator, and said current indicator not being exposed when current is not flowing using only using only the magnetic field created by flowing current in said conductors.

2. The structure as recited in claim 1 wherein said ferrofluid is contained in a predefined volume of said compartment of the power plug connector.

3. The structure as recited in claim 1 wherein said window includes a transparent window enabling visual observation of said current indicator, said current indicator underlying said transparent window.

4. The structure as recited in claim 3 wherein said transparent window is formed of an impact resistant plastic.

5. The structure as recited in claim 1 wherein said connector body includes a plug shell.

6. The structure as recited in claim 5 wherein said ferrofluid is received within said compartment defined by a recess formed in said plug shell.

7. The structure as recited in claim 6 includes said current indicator received within said recess formed in said plug shell.

8. The structure as recited in claim 6 wherein said window includes a transparent window covering said recess formed in said plug shell.

9. The structure as recited in claim 8 wherein said ferrofluid covers said current indicator when current is not flowing, and said ferrofluid is moved to expose said current indicator when current is flowing in said conductors.

10. The structure as recited in claim 1 wherein said connector body is formed of a selected electrically insulative material having predefined rigidity and strength.

11. The structure as recited in claim 1 wherein said ferrofluid is formed by about 5% magnetic solids, 10% surfactant, and 85% carrier, by volume.

12. The structure as recited in claim 11 wherein said ferrofluid is formed by magnetite for the magnetic particles, oleic acid as the surfactant, and kerosene as the carrier fluid to suspend the particles.

13. A method for implementing a current indicator for electrical power plug connectors comprising;
providing a power plug connector including a connector body; said connector body encasing a plurality of conductors;
providing a window in said connector body positioned between selected ones of said plurality of conductors;
providing a compartment embedded into the power plug connector containing a ferrofluid and containing a current indicator; and
providing said current indicator disposed below said window, said ferrofluid being influenced by a magnetic field created by flowing current in said conductors to expose said current indicator, and said current indicator not being exposed when current is not flowing using only using only the magnetic field created by flowing current in said conductors.

14. The method as recited in claim 13 includes providing said compartment defined by a predefined volume within said power plug connector receiving said ferrofluid.

15. The method as recited in claim 14 wherein providing said window includes providing a transparent, impact resistant plastic window over said predefined volume containing said ferrofluid.

16. The method as recited in claim 15 includes providing said current indicator received in said predefined volume, said ferrofluid covering said current indicator and said current indicator not visible when current flow is not present.

17. The method as recited in claim 16 wherein said transparent window enabling visual observation of said current indicator, said current indicator underlying said transparent window.

18. The method as recited in claim 16 wherein said ferrofluid moving and exposing said current indicator when current flow is present in said conductors.

19. The method as recited in claim 13 includes providing said connector body formed of a selected electrically insulative material having predefined rigidity and strength, and said ferrofluid is formed by about 5% magnetic solids, 10% surfactant, and 85% carrier, by volume.

20. The method as recited in claim 19 wherein said ferrofluid is formed by magnetite for the magnetic particles, oleic acid as the surfactant, and kerosene as the carrier fluid to suspend the particles.
